(19) United States
(12) Patent Application Publication
(10) Pub. No.: US 2006/0031343 A1
(43) Pub. Date: Feb. 9, 2006

(54) Integrated instant message system with gateway functions and method for implementing the same

(75) Inventor: Tarn Liang Chern, SanChung (TW)

Correspondence Address: WILSON SONSINI GOODRICH & ROSATI, 650 PAGE MILL ROAD, PALO ALTO, CA, 94304-1050, US

(73) Assignee: XCOME TECHNOLOGY CO., INC.

(21) Appl. No.: 10/992,783

(22) Filed: Nov. 22, 2004

(30) Foreign Application Priority Data
Jul. 9, 2004 (TW) 093120598

(51) Int. Cl. G06F 15/16

(52) U.S. Cl. 709/206; 709/227

(57) ABSTRACT

The present invention discloses an integrated instant message system including gateway functions and a method for implementing the same. In the integrated instant message system, a user is used as a session initiator. The session initiator builds a session for passing instant messages through a network medium. In the session, the session initiator is used as a gateway in order to invite other clients in networks to join in the session. Because the session initiator provides other instant message functions, it accepts connections from the users of other instant message systems in order to integrate the clients of different instant message systems in the session.

### BACKGROUND OF THE INVENTION

1. Field of the Invention

The present invention relates to an instant message system for use in Internet and mobile communication networks and a method for implementing the same and, more particularly, to an integrated instant message system with gateway functions and a method for implementing the same.

2. Description of the Related Art

Due to fast developing of Internet communication technology, various instant messengers for use in Internet and mobile communication networks are prospering. Through the instant messengers, communication between people is no longer limited by space and time. Using desktop computers, notebook computers, or palmtop computers, users can conduct instant message communication through Internet (including wireless and cable networks) anywhere, anytime. Alternatively, using mobile phones, users can conduct instant message communication through the mobile communication networks (including high and low tier mobile phone networks).

Referring to FIG. 1, a typical instant message system includes clients 130, 140 and 150. The clients are connected with an electronic device (such as the computers and the mobile phones) of a network medium 120 (such as Internet and the mobile communication networks). The electronic device executes an instant message system software program for connection with a server 110 of the instant message system. Any client can invite any other client to conduct instant message communication. In that case, the server 110 initiates a session so that the users can send text and files and can even conduct multi-party on-line voice and video conference calls.

The typical instant message system uses a client-server structure. Several problems are encountered in the use of the typical instant message system. Firstly, service cannot be provided when the server crashes. The clients have to log on through the server, and conduct instant transmission of messages through the server in the session. When the server crashes, no service can be provided, and the clients cannot be served through the server. This problem can be obviated by means of a cluster server or a backup server; however, the cost of service will be increased.

Secondly, users in different instant message systems cannot communicate. The instant message systems compete with one another. The users in the different instant message systems cannot communicate for not being able to tear down barriers between the different instant message systems. Thus, a user is often forced to join in many instant message systems in order to get in touch with all his or her friends.

### SUMMARY OF THE INVENTION

The primary object of the present invention is to provide an instant message system not in need of a server and a method for implementing the same so that users can conduct instant message communication when the server crashes.

Another object of the present invention is to provide an integrated instant message system and a method for implementing the same in order to integrate users of different instant message systems in a session.

In order to achieve the foregoing objects, the present invention discloses an integrated instant message system including gateway functions and a method for implementing the same. In the integrated instant message system, a user device is used as a session initiator. The session initiator builds a session for passing instant messages through a network medium. In the session, the session initiator is used as a gateway in order to invite users in other networks to join in the session. Because the session initiator provides other instant message functions, it renders connections with the other instant message systems possible in order to integrate the users of different instant message systems in the session.

In the present invention, a user device is used as a session initiator with gateway functions. Other clients joining in the session can conduct instant message transmission through the session initiator with the gateway functions without the use of a server. The session initiator provides other instant message functions, which integrate the users of different instant message systems in the session. Thus, the problem that a session cannot be built when a server crashes in the typical instant message system and the problem that users of different instant message systems cannot communicate are both solved.

### BRIEF DESCRIPTION OF THE DRAWINGS

FIG. 1 shows the structure of a typical instant message system;

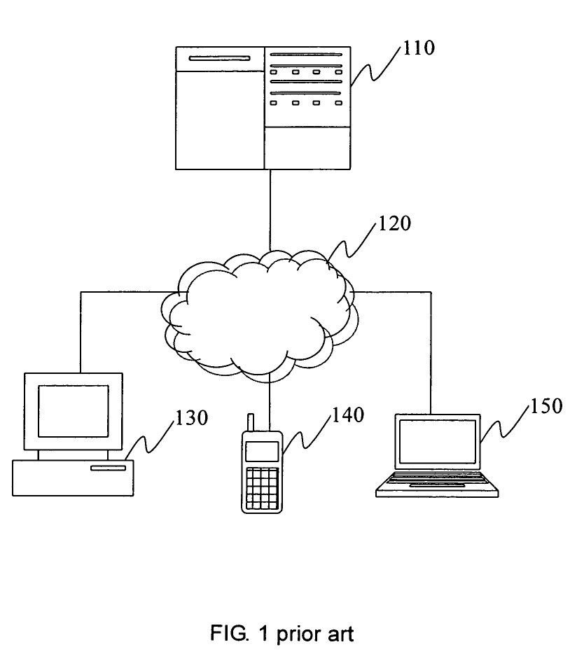

FIG. 2 shows the structure of an instant message system according to the preferred embodiment of the present invention;

FIG. 3 is a block diagram of the structure of the instant message system shown;

FIG. 4 is a flow chart of a portion of a process in which a session initiator builds and terminates a session in the instant message system;

FIG. 5 is a flow chart of a process in which the session initiator invites the session participant; and

FIG. 6 is a flow chart of a process in which the session initiator receives and passes instant messages.

### DETAILED DESCRIPTION OF PREFERRED EMBODIMENT OF THE INVENTION

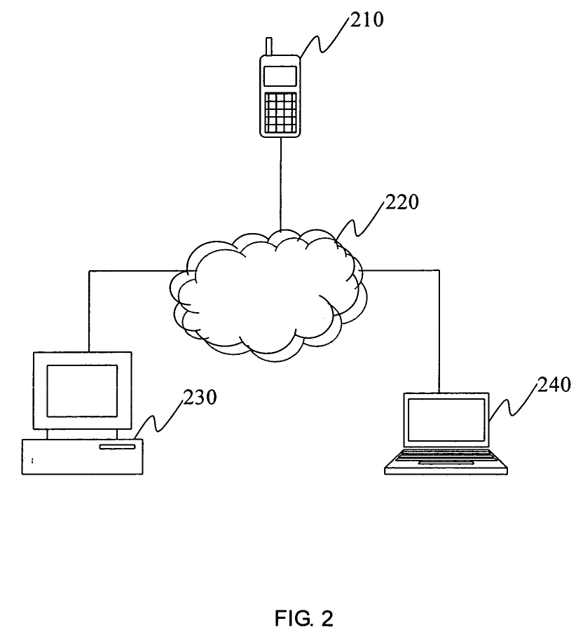

Referring to FIG. 2, according to the preferred embodiment of the present invention, an instant message system includes a session initiator 210 that builds a session for passing instant messages through a network medium 220, and invites session participants 230 and 240. The session participants 230 and 240 are connected with the session initiator 210 in a peer-to-peer manner. In the session, the session initiator 210 is responsible for passing the instant messages. Therefore, the instant message system of the present invention can operate without a server. The session initiator 210 provides other instant message functions so that it renders connection with other instant message systems possible in order to integrate users of different instant message systems in the session. The session initiator 210 is responsible for terminating the session.

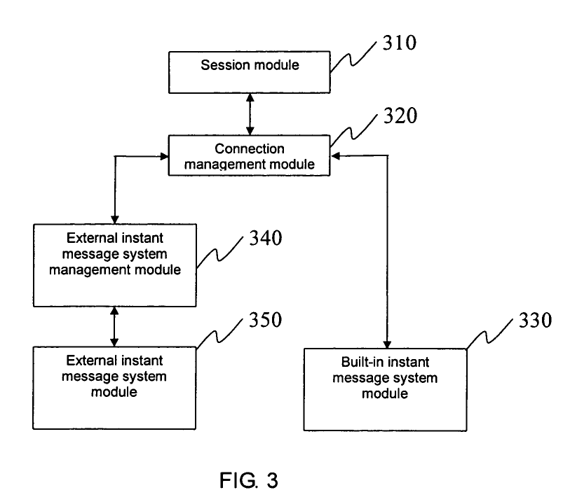

FIG. 3 shows the configuration of the integrated instant message system with gateway functions of the present invention. It is executed in an electronic device (such as computers and mobile phones) of a network medium. It can be used as a session initiator in order to build a session for passing instant messages and can be used as a gateway for passing the instant messages in the session. Thus, built-in instant message system clients are connected with external instant message system clients. The session initiator is responsible for terminating the session. Moreover, the client in which the system is executed can be used as a session participant joining in a session initiated by means of another session initiator. To the session initiator, the session participants are built-in instant message system clients. The system includes a session module 310, a connection management module 320, a built-in instant message system module 330, an external instant message system module 350, and an external instant message system management module 340.

The session module 310 is used to build and terminate a session and shows the content of the session. When a session initiator invites session participants, the session module 310 is actuated. The session module 310 conducts hand shaking with each session participant in order to determine whether the session participant is available for connection and what instant message system communication protocol to use in order to build the connection. After the hand shaking, the session module 310 builds a connection pool in order to maintain all connections in the session, and shows the content of the session, and finally terminates the session.

The connection management module 320 is used to manage the connections in the session. When the connection pool is built, the connection management module 320 is responsible for managing the connections in the connection pool. The connection management module 320 passes messages to the session module 310 from the session initiator in order to show the content or receives messages from the session module 310 in order to pass the messages to a specific connection in the connection pool. The specific connections are classified into two types, i.e., connections built by means of the built-in instant message system clients and connections built by the external instant message system clients.

The built-in instant message system module 330 is used to communicate with the built-in instant message system clients. The built-in instant message system module 330 includes a built-in instant message system communication protocol. When having to pass messages to the built-in instant message system client or receive messages from the built-in instant message system client, the connection management module 320 actuates the built-in instant message system module 330 so that the built-in message system communication protocol can pass and receive the messages.

The external instant message system module 350 is used to communicate with the external instant message system clients. The instant message system of the present invention may include more than one external instant message system modules 350. Each external instant message system module 350 includes an external instant message system communication protocol. When having to pass messages to the external instant message system client or receive messages from the external instant message system client, the connection management module 320 actuates the external instant message system module 350 through the external instant message system management system 340 so that the external message system communication protocol can conduct the transmission and receipt of the messages.

The external instant message system management module 340 is used to manage the external message system modules 350 needed in the session. The session initiator is a gateway that integrates other instant message systems. The external instant message system management module 340 is used to manage the external message system modules 350 needed in the session. When passing messages to the external instant message system client, the connection management module 320 calls the external instant message system management module 340, and the external instant message system management module 340 determines what types the external instant message systems are. On the contrary, when receiving messages from Internet, the external instant message system management module 340 determines what types the external instant messages systems are. After the determination, the external instant message system management module 340 calls appropriate external instant message system modules 350 in order to pass and receive the messages.

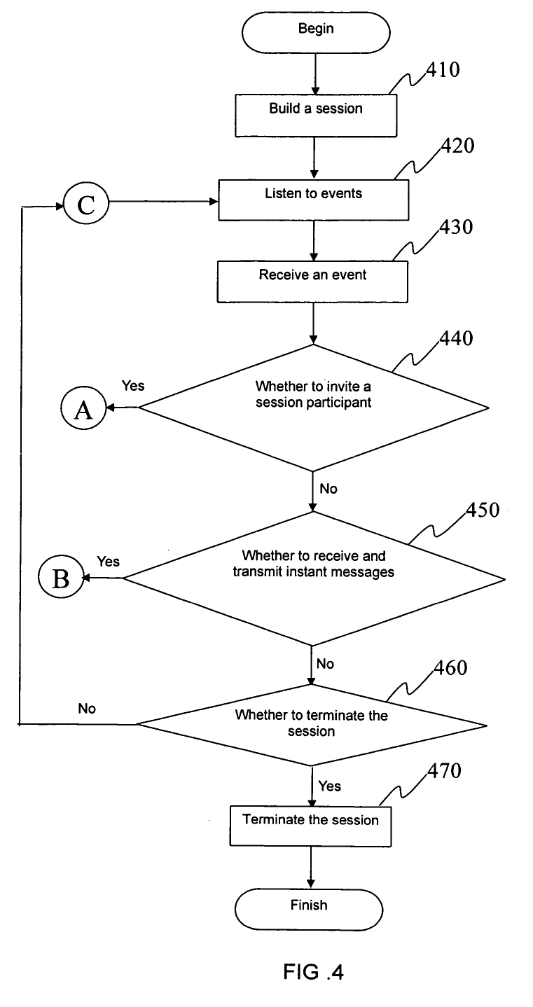

FIG. 4 is a flow chart of a portion of a process in which a session initiator builds and terminates a session in the instant message system of the present invention. Referring to FIG. 4, the session initiator is a device in which the integrated instant message system with the gateway functions is executed. The session initiator builds a session (Step 410), and listens to all events in the session (Step 420). The events could be user of the session initiator entering a command or the session initiator receiving messages from a session participant. When the session initiator receives an event (Step 430), it will determine whether the event is a user inviting a participant (Step 440). If so, the session initiator will invite the session participant (to be described in detail). If not, the session initiator will determine whether it has messages to pass or receive (Step 450). If so, the session initiator will pass or receive the messages (to be described in detail). If not, the session initiator will determine whether the event is the user about to terminate the session (Step 460). If so, the session initiator will terminate the session (Step 470). If not, the session initiator will retain the session and keep on listening to events.

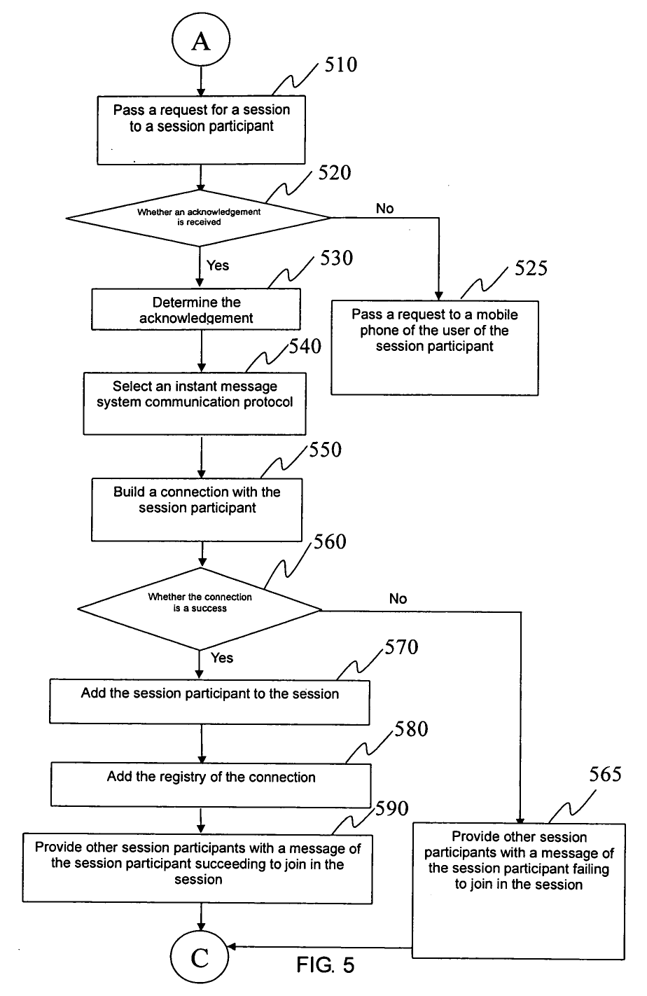

FIG. 5 is a flow chart of a process in which the session initiator invites the session participant. Referring to FIG. 5, the session initiator has built a session for the transmission of the instant messages. The session initiator passes a request to the session participant according to email address or telephone number of the session participant (Step 510). After receiving the request, the session participant acknowledges the request and the session initiator receives the acknowledgement (Step 520). If the session participant does not acknowledge, the session initiator will pass another request to a mobile phone of the session participant (Step 525). For example, through a short message system of a mobile communication network, the session initiator can pass a short message to the mobile phone of the session participant in order to invite the session participant to join in the session.

Based on the received acknowledgement, the session initiator determines whether the session participant is a client of the built-in instant message system or a client in the external instant message system (Step 530). If the session participant is a client of the built-in instant message system, the session initiator will select the built-in message system communication protocol (Step 540), and attempts to build a connection with the session participant (Step 550). If the session participant is a client of the external instant message system, the session initiator will select the external message system communication protocol (Step 540), and attempts to build a connection with the session participant (Step 550). If a connection is built, the session participant will join in the session (Step 570), and the registry of the connection is added (Step 580). A message of the session participant joining in the session is passed to other session participants (Step 590). If a connection is not built, a message of the session participant failing to join in the session will be passed to other session participants (Step 565).

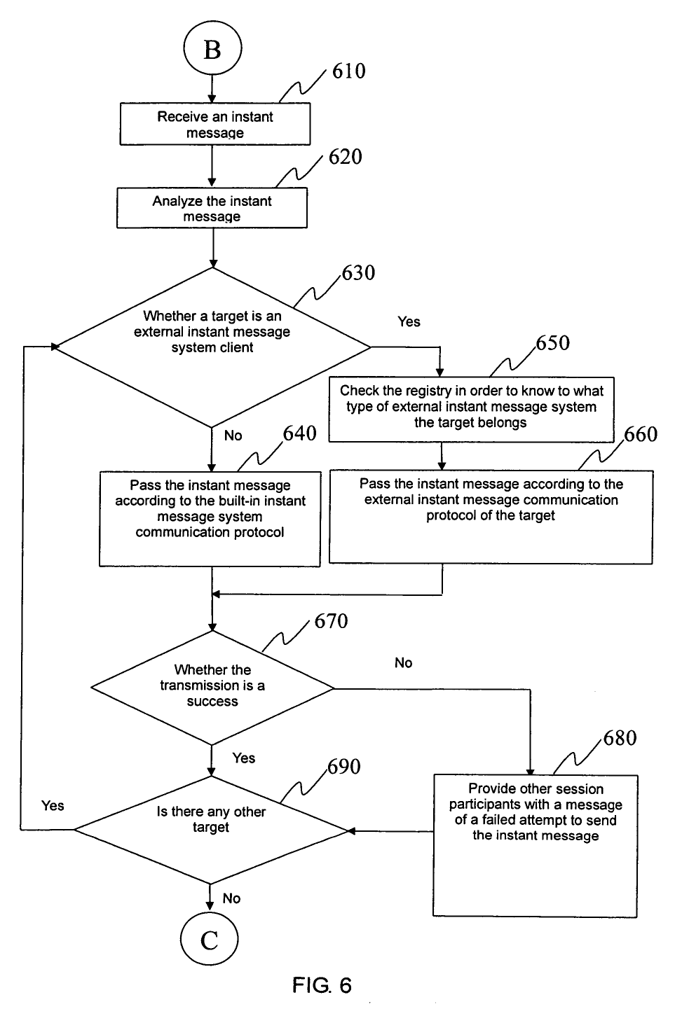

FIG. 6 is a flow chart of a process in which the session initiator receives and passes instant messages. Referring to FIG. 6, the session initiator receives an instant message (Step 610). The instant message could come from a session participant or the session initiator. After analyzing the instant message (Step 620), the system passes the instant message to other session participants (“targets”) than the session participant that passes the instant message. The session initiator will take the following steps for every target. The system determines whether the garget is a client of an external instant message system (Step 630). If not, the system will pass the instant message according to the built-in instant message system communication protocol (Step 640). If so, the system will check the registry in order to know what type of external instant message system the target belong to (Step 650), and will pass the instant message according to the external instant message system communication protocol of the target (Step 660), and will determine whether the transmission is successful (Step 670). If not, the system will provide the other session participants with a message of a failed attempt to pass the instant message (Step 680). The system will determine whether there is another target (Step 690). If so, the system will determine whether the target is a client of an external instant message system (Step 630). If there is no other target, the system will finish the receipt or transmission of the instant message.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. An integrated instant message system with gateway functions, said system comprising:
a session module for building and terminating a session in a network medium and for showing instant messages passed in said session;
a connection management module for managing connections in said session;
a built-in instant message system module for communicating with built-in instant message system clients in said session;
an external instant message system module for communicating with external instant message system clients in said session; and
an external instant message system management module for managing said external instant message system module.

2. The system according to claim 1 wherein said network medium comprises Internet, high tier mobile phone system networks, and low tier mobile phone system networks.

3. The system according to claim 1 wherein said instant messages comprises files, text, voice, images, images and videos.

4. The system according to claim 1 wherein said connections in said session comprises peer-to-peer connections.

5. A method for implementing an integrated instant message system with gateway functions, said method comprising the steps of:
building a session;
passing a request to a session participant;
receiving an acknowledgement from said session participant;
selecting an instant message system communication protocol;
building a connection with said session participant;
receiving and passing instant messages; and
terminating said session.

6. The method according to claim 5 wherein the step of receiving said acknowledgement from said session participant further comprises the step of passing a request to a mobile phone of a client of said session participant if there is no acknowledgement from said session participant.

7. The method according to claim 5 wherein the step of building said connection with said session participant further comprises the step of passing a message to other session participants in the session if the attempt to build a connection fails.

8. The method according to claim 5 wherein the step of receiving and passing said instant messages further comprises the step of passing a message to other session participants in said session if the attempt to send said instant messages to a session participant fails.

9. The method according to claim 5 wherein the step of building a connection with said session participant comprises building peer-to-peer connections with said session participants.
